(19) United States
(12) Patent Application Publication
(10) Pub. No.: US 2004/0152057 A1
(43) Pub. Date: Aug. 5, 2004

(54) Learning keyboard for children

(76) Inventor: Novia Chen, Chang Hua Hsien (TW)

Correspondence Address: BIRCH STEWART KOLASCH & BIRCH, PO BOX 747, FALLS CHURCH, VA, 22040-0747, US

(21) Appl. No.: 10/358,186

(22) Filed: Feb. 5, 2003

(51) Int. Cl. G09B 13/00

(52) U.S. Cl. 434/227; 434/365

(57) ABSTRACT

A learning keyboard for children utilizes different colors to separate key positions corresponding to left and right hands' fingers at the typing region of a keyboard. Fonts at each key position are livelier and smarter, and symbol at each key position are enlarged. Simultaneously, through the operation of a software, when a user presses down any key at the typing region, which kind of color the key belongs to is immediately determined, and the music of a children's song is played to help memorization, thereby helping the user learn the correct way of keyboard input and letting learning be livelier and funnier.

### FIELD OF THE INVENTION

The present invention relates to a learning keyboard for children and, more particularly, to a keyboard capable making use of smart fonts, enlarged symbols, visual effects of colors, and matched children's songs to help memorization.

### BACKGROUND OF THE INVENTION

Most commercially available keyboards for children utilize pretty styles or fashionable animal patterns as their selling point. For instance, FIG. 1 shows a keyboard having a monkey pattern. The functions of keyboards for children are less concerned.

There is also a kind of color keyboard, whose keys are designed with different colors to facilitate the learning of correct typing. However, the function in aided learning of the keyboard is not satisfactory.

Accordingly, the present invention aims to propose a keyboard, which not only can facilitate the learning of correct typing for children, but also can help memorization to enhance the learning will of children.

### SUMMARY OF THE INVENTION

One object of the present invention is to provide a keyboard, which makes use of smart fonts, enlarged symbols, visual effects of colors, and matched children's songs to help memorization. Through helping a child learn the correct way of keyboard input, learning becomes lively and funny, thereby enhancing the learning will of the child.

To achieve the above object, the present invention utilizes four different colors to separate key positions corresponding to left and right hands' fingers at the typing region of a keyboard. The letter at each key position is livelier and smarter, and the symbols at each key position is enlarged to facilitate search of a letter to be inputted. Simultaneously, through the operation of a software built in a keyboard controller of the keyboard, or installed to a computer system using this keyboard, when a user presses down any key at the typing region, which kind of color the key belongs to is immediately determined, and a component capable of giving off sound plays the music of a children's song to help the user memorize.

The various objects and advantages of the present invention will be more readily understood from the following detailed description when read in conjunction with the appended drawing, in which:

### BRIEF DESCRIPTION OF THE DRAWINGS

FIG. 1 is a perspective view of a conventional keyboard;

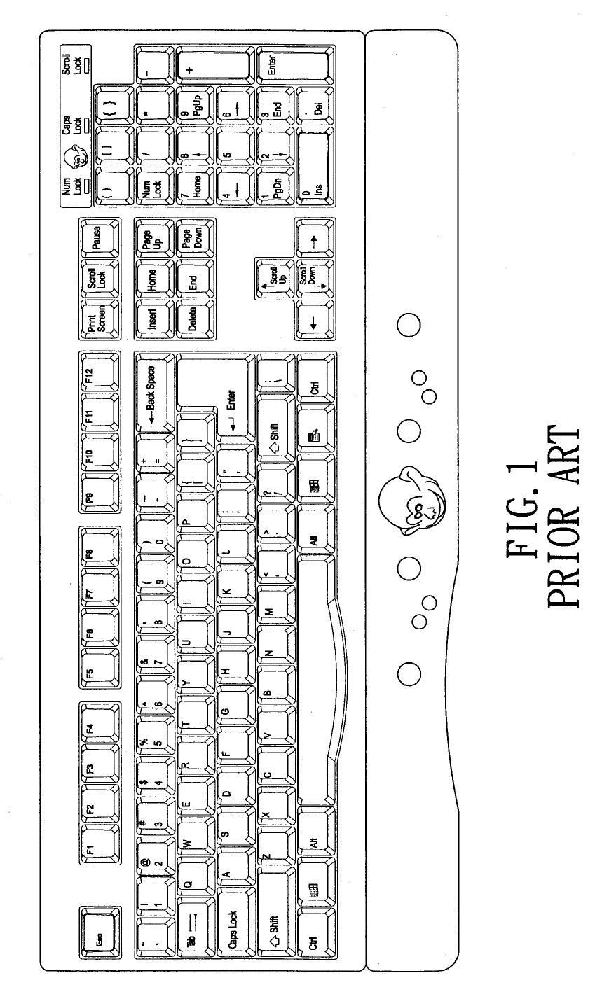

FIG. 2 is a perspective view of a learning keyboard for children of the present invention; and

FIG. 3 is a flowchart of a software used for a learning keyboard for children of the present invention.

### DETAILED DESCRIPTION OF THE PREFERRED EMBODIMENTS

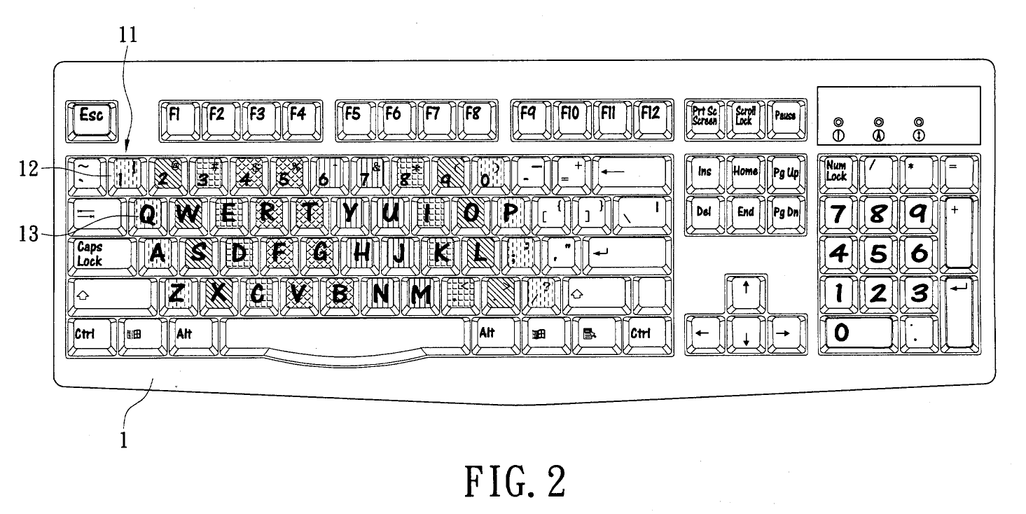

As shown in FIG. 2, the present invention provides a learning keyboard for children 1, which utilizes several kinds of different colors to separate key positions 12 corresponding to left and right hands' fingers at a typing region 11 of the keyboard 1, thereby enhancing the learning will of children. The letter at each key position 12 is livelier and smarter, and the symbols 13 at each key position 12 is enlarged to facilitate search of a letter to be inputted. Simultaneously, through the operation of a software built in a keyboard controller in the keyboard 1, or installed to a computer using this keyboard 1, when a child presses down any key at the typing region 11, which kind of color the key belongs to is immediately determined, and a sound component capable of giving off sound plays the music of a children's song to help the child learn the correct way of keyboard input and let learning be lively and funny.

The typing region 11 of the keyboard 1 is separated into the key positions corresponding to left and right hands' fingers with different colors. In the embodiment of the present invention, purple, green, yellow and red colors correspond to the key positions corresponding to left and right hands' fingers. For instance, the purple color corresponds to little fingers-(purple: little fingers). Symbols corresponding to the purple color include “1”, Q”, “A”, “Z”, “0”, “P”, “;” and “/”.

The green color corresponds to ring fingers (green: ring fingers). Symbols corresponding to the green color include “2”, “W”, “S”, “X”, “9”, “O”, “L” and “.”.

The yellow color corresponds to middle fingers (yellow: middle fingers). Symbols corresponding to the purple color include “3”, “E”, “D”, “C”, “8”, “I”, “K” and “,”.

The red color corresponds to index fingers (red: index fingers). Because the left and right hands' index fingers are adjacent to each other, in order to avoid confusion, the red color corresponding to the index fingers will be discriminated by different chromas. Symbols corresponding to the red color include “4”, “5”, “R”, “T”, “F”, “G”, “V”, “B”, “6”, “7”, “U”, “H”, “J”, “N” and “M”.

The symbols 13 at each key position 12 can be changed according to the user's need.

The software utilizes the melody of “two tigers” and recomposes its lyrics to help memorization so as to achieve interaction with the user. The recomposed lyrics are as follows.

| | |
|---|---|
| Purple for Little | Purple for Little; |
| Green for Ring | Green for Ring; |
| Middle is Yellow | Middle is Yellow; |
| Index is Red | Index is Red. |

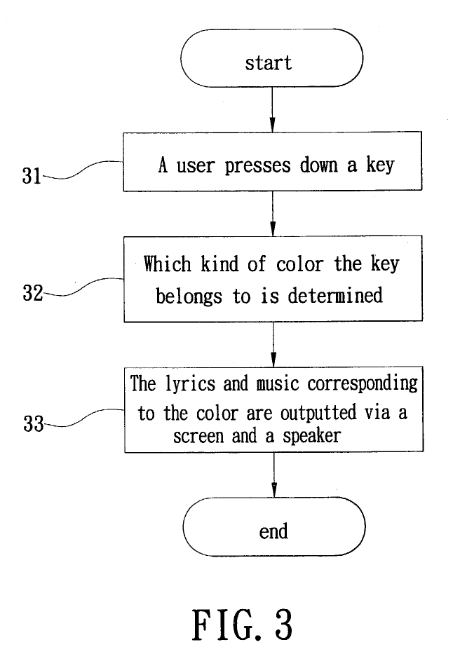

FIG. 3 is a flowchart of the software for interaction of the keyboard of the present invention and the user. The flowchart comprises the following steps.

Step 31: A user presses down a key.

Step 32: Which kind of color the key belongs to is determined.

Step 33: The lyrics and music corresponding to the color are outputted via a screen and a speaker.

For example, when a key belongs to the purple color is pressed down, the lyrics of “Purple for Little” are displayed on the screen, and the music is played via a component (speaker) capable of giving off sound to help memorization and simultaneously accomplish interaction with the user.

Therefore, when a user presses down any key at the typing region 11 of the keyboard 1, the software built in the keyboard 1 or installed to a computer system using the keyboard 1 will determine which color the key belongs to, and the music of a children's song is played via the speaker to help memorization, hence accomplishing interaction with the user.

To sum up, the present invention has the following characteristics.

1. Because variation of font and visual effects of colors are utilized on the keyboard, a user can easily memorize the pressed key positions of fingers.

2. Because children's songs can be matched in use of the keyboard to help memorization, more fun can be achieved to enhance the will of children for learning keyboard input.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A learning keyboard for children, comprising
a typing region with a plurality of key positions assigned with different colors corresponding to left and right hands' fingers, the typing region having a plurality of keys with enlarged symbols, each key having a specific color associated with the key position thereof
a software means to identify a color corresponding to a pressed key in the typing region and to drive a sound-playing device for playing a music of a children' song corresponding to the pressed-key.

2. The learning keyboard for children as claimed in claim 1, wherein fonts at each said key position can be changed according to user's need.

3. The learning keyboard for children as claimed in claim 1, wherein purple, green, yellow and red colors are used to separate said key positions corresponding to left and right hands' fingers at said typing region of said keyboard.

4. The learning keyboard for children as claimed in claim 3, wherein said key positions of the purple color correspond to left and right hands' little fingers.

5. The learning keyboard for children as claimed in claim 3, wherein said key positions of the green color correspond to left and right hands' ring fingers.

6. The learning keyboard for children as claimed in claim 3, wherein said key positions of the yellow color correspond to left and right hands' middle fingers.

7. The learning keyboard for children as claimed in claim 3, wherein said key positions of the red color correspond to left and right hands' index fingers.
